(19) United States
(12) Patent Application Publication
(10) Pub. No.: US 2021/0231347 A1
(43) Pub. Date: Jul. 29, 2021

(54) INSTANT WATER HEATER

(71) Applicant: Atmor Industries Ltd., KFAR SABA (IL)

(72) Inventor: Avi Avraham Vahaba, Timorim (IL)

(73) Assignee: Atmor Industries Ltd., KFAR SABA (IL)

(21) Appl. No.: 17/262,458

(22) PCT Filed: Aug. 22, 2019
(86) PCT No.: PCT/IL2019/050946

§ 371 Date: Jan. 22, 2021

Related U.S. Application Data
(60) Provisional application No. 62/721,730, filed on Aug. 23, 2018.

(51) Int. Cl. F24H 9/20; F24H 1/10; F24H 9/12; H05B 1/02; G01F 1/20

(52) U.S. Cl. CPC F24H 9/2028; F24H 1/102; G01F 1/20; H05B 1/0202; F24H 9/128

(57) ABSTRACT

An open-vented instant water heater is configured so as to prevent damaging thereof in cases of incorrect installation. The water heater comprises a water canister with a heating element and has a normally open outlet pipe, wherein the outlet pipe is provided with a flow sensing device comprising: a one-way valve which allows water to flow from the canister toward the outer end of the outlet pipe while preventing a water flow in the opposite direction, and/or a water flow mechanism adapted to switch the heating element OFF whenever detecting in the outlet pipe either a water flow towards the canister, or absence of any water flow.

### FIELD OF THE INVENTION

The present invention relates to water heating devices, more specifically to instant water heaters.

### BACKGROUND OF THE INVENTION

Water heating devices for industrial and domestic use are known in the art. A separate group of water heating devices is formed by instant electric water heaters that provide hot water on demand, without heating the water in advance.

A sub-group of such instant electric water heaters comprises domestic devices which may be found on the customers' market. Domestic instant water heaters are provided with an internal heating element adapted to instantly heat the inlet cold water as it flows through the device and the heating element, so as to deliver hot water to the outlet of the device. Domestic instant water heaters may be configured for supplying hot water to a shower head, to a pipe above a sink, etc.

An exemplary instant water heater may be configured, for example, as an open-vented device schematically shown in FIG. 1 (prior art).

A simple instant water heater 10 may comprise an inlet pipe 12 for letting water into the heater, a manually operated water valve 14 (flow regulator) for regulating the water flow between the inlet pipe 12 and an input (middle) pipe 16, a pressure switch 17 (presostat) for detecting water pressure, a unit 18 for quick (instant) heating of the water entering from the middle pipe 16, and an outlet pipe 20 normally open to atmosphere, which allows discharge of the hot water from the unit 18. The water valve 14 may be part of the heater device 10, but may be an external (user's) water tap to which the inlet pipe 12 (also external) is connected. In FIG. 1, the heating unit 18 is controlled by the valve 14 associated with the pressure switch 17, as follows:
when a sufficient water flow from the middle pipe 16 enters the heating unit 18, it will be turned ON, so the water flow will be instantly heated by the unit 18 and the hot water will be discharged via the outlet pipe 20;
when water in the middle (input) pipe 16 is absent, or when its pressure in the pipe 16 is insufficient (which happens when the flow regulator 14 closes the passage between the inlet pipe 12 and the middle pipe 16), the heating unit 18 will be turned OFF.

Water heaters of the above type are sensitive to the way they are installed, so any inaccuracy in that may cause various problems. Customers, who acquire such instant water heaters and install the heaters themselves, often make mistakes during the installation. The installation mistakes may bring a serious damage to the device.

### OBJECT AND SUMMARY OF THE INVENTION

Customers or non-experienced plumbers may make the following typical mistakes when installing a device of the type shown in FIG. 1:
a) inverted installation of the outlet and inlet water pipes,
b) connecting the outlet pipe to any water tap, stopper etc., which closes the outlet pipe—for example, when turned by the user.

Any one of the above mistakes is enough to cause an irreversible damage to a heating element and/or other components of the device, and that is a drawback of an open-vented water heater. Indeed, if (a) or (b), or both of them are erroneously applied, closure of the water valve 14 and/or of any stopper erroneously connected to the outlet pipe 20 will cause trapping of the water in the heating unit 18 of the device, the pressure switch 17 will detect water pressure in the pipe 16 and the device will continuously heat the water up to damaging the whole device 10.

It is therefore an object of the present invention to increase reliability of the device and to overcome its above-mentioned drawback by preventing damages to the device, for example in case of any erroneous installation.

The above object can be achieved by providing an open-vented instant water heater configured so as to prevent damaging thereof in case of incorrect installation, said water heater comprises a water canister with a heating element and a normally open outlet pipe,

wherein the outlet pipe is provided with a flow sensing device comprising at least one of the following:
a one-way valve (so as to allow water to flow from the canister toward an outer end of the outlet pipe and to prevent water flow in the opposite direction, i.e. from the outlet pipe toward the canister),
a water flow mechanism (a so-called “outlet” water flow mechanism) adapted to switch the heating element OFF, whenever detecting in the outlet pipe either a water flow toward the canister, or absence of a water flow.

The proposed open-vented instant water heater may preferably be arranged to have:
an input (middle) pipe,
said water canister being in flow communication with the input (middle) pipe and the outlet pipe,
said heating element adapted for instantly heating water in the canister,
a thermostat in the canister,
a water pressure mechanism or an “inlet” water flow mechanism, being associated with the middle (input) pipe for respectively determining water pressure or water flow in that pipe,
wherein
   water flow via the input (middle) pipe is regulated by a water valve, preferably manually operated
   the heating element is controllable using said water pressure or said “inlet” water flow mechanism, by switching the heating element ON when a predetermined water pressure or a predetermined water flow is determined in the middle pipe.

If the proposed open-vented water heater is installed correct, the pre-installed one-way valve will not be felt at all, but in case of inverse installation the one-way valve will prevent the water arriving from the wrong direction from filling the canister. Preferably, said one-way valve is embedded in the outlet pipe in proximity to the outer end of the pipe, thus allowing a water flow from the outlet pipe outside, but blocking a water flow from outside to the outlet pipe and then to the canister. Optionally, an additional one-way valve may be provided in the outlet pipe, to provide double safety (for example if the outer valve is lost/incidentally separated during installation or re-installation).

As mentioned above, the flow sensing device may have another embodiment. Alternatively or in addition to the one-way valve, the proposed instant water heater may be provided with a water flow mechanism connected to the outlet pipe (so-called “outlet” water flow mechanism).

The water flow mechanism of interest should be sensitive to the following events: presence/absence of a water flow in a pipe, and to direction of the water flow in the pipe.

For example, the water flow mechanism (flow sensor) may comprise a first part being a magnet placed in a ball-like shell made of plastic, silicon or the like, and a second part being a magnetic detector. The ball may be placed in the outlet pipe, and the magnetic detector (for example, an electromagnetic assembly) may be located at specific position/s outside the outlet pipe but in proximity to it. Such a flow sensor will be capable of providing indications of presence/absence and direction of a water flow in the pipe, with a predetermined accuracy.

The invention provides for switching OFF the heating element whenever the “outlet” water flow mechanism detects in the outlet pipe either absence of a water flow, or a predetermined water flow in the wrong direction (namely, in the direction from the outlet pipe towards the heating unit/canister).

If one of the mentioned events takes place, the “outlet” water flow mechanism will thus react on mistake a) or mistake b) in the installation. Based on that reaction, the heating element will be switched OFF. In case of mistake b), the water flow mechanism will detect absence of flow (of the static water) in the outlet pipe, i.e., will act as a clogging sensor. Such a “clogging sensor” will help preventing damages to the device both in case when sediments or the like have incidentally aggregated in the outlet pipe, and in case when the outlet pipe was erroneously connected to a water tap/valve which some-when becomes closed.

Indication of installation mistakes may be optionally provided in the device; such indication may be initiated, for example, by the “outlet” water flow mechanism installed in/at the outlet pipe.

Preferably, the heater may also be provided with a manually operated power setting switch, for regulating power of the heating element. The switch may, for example, allow a user to manually select one of possible power levels, thus obtaining hot water at a desired temperature range.

The heater may be further provided with a drain pipe for outputting overflow of water or steam from the water canister outside. The drain pipe serves as additional means for preventing damages to the heater, when the water flow in the canister is too strong and/or when the water is boiling.

It should be kept in mind that the manually operated water valve which regulates water flow through the input (middle) pipe, is usually connected between the mentioned pipe and an inlet pipe. The water valve may be internal or external. If the water valve is internal, the heater may also accommodate an inlet pipe which is usually connected to a pressure hose. If the water valve is external (for example, in the form of an external water tap), it usually interconnects an external inlet pipe and the input (middle) pipe of the water heater.

According to a further aspect of the invention, there is also provided a method for preventing damage of incorrect installation to an open-vented instant water heater having a canister with a heating element and a normally open outlet pipe, the method comprises
providing the water heater having a flow sensing device at the outlet pipe, the flow sensing device comprising a one-way valve and/or a water flow mechanism (which was called an “outlet” water flow mechanism above in the description).

If the water heater comprises the “outlet” water flow mechanism, the method may comprise controlling the water heater as follows:
switching the heating element OFF if said mechanism detects in the outlet pipe either absence of a water flow, or a water flow towards the water canister, thereby preventing damage to said water heater (both in cases of incorrect installation and in cases of clogging the outlet pipe).

The method may further comprise installing a power setting switch (power selector), obtaining a setting signal there-from and using the setting signal for regulating power of the heating element.

Still further, the method may comprise providing indication in case of incorrect installation of the water heater. For example, the indication may be based on events detected by the outlet water flow mechanism, and may be provided by light diodes on the heater's housing.

The invention will be described in more details as the description progresses.

### BRIEF DESCRIPTION OF THE DRAWINGS

The invention will be further described in detail with reference to the following non-limiting drawings, in which:

FIG. 1 (prior art) illustrates a simplified diagram of a known configuration of an open-vented instant water heater.

FIG. 2A and 2B show and explain some options of correct installation of the water heater schematically shown in FIG. 1.

FIG. 2C schematically illustrates and explains cases of incorrect installation of the water heater schematically shown in FIG. 1.

FIG. 3 schematically illustrates a one-way valve installed in the outlet pipe of the proposed heater.

FIG. 4 schematically illustrates one embodiment of the proposed heater, comprising a one-way valve shown in FIG. 3.

FIG. 5 schematically illustrates a more detailed embodiment of the proposed heater with a thermostat, a power setting switch and a draining pipe.

FIG. 6 illustrates an exploded view of yet a more detailed embodiment of the proposed heater, showing the water pressure mechanism (switch), a power setting switch, connection lines for controlling the heating element in the water canister, etc.

FIG. 7 illustrates a further embodiment of the proposed heater, comprising an “outlet” water flow mechanism at the outlet pipe.

### DETAILED DESCRIPTION OF THE EMBODIMENTS

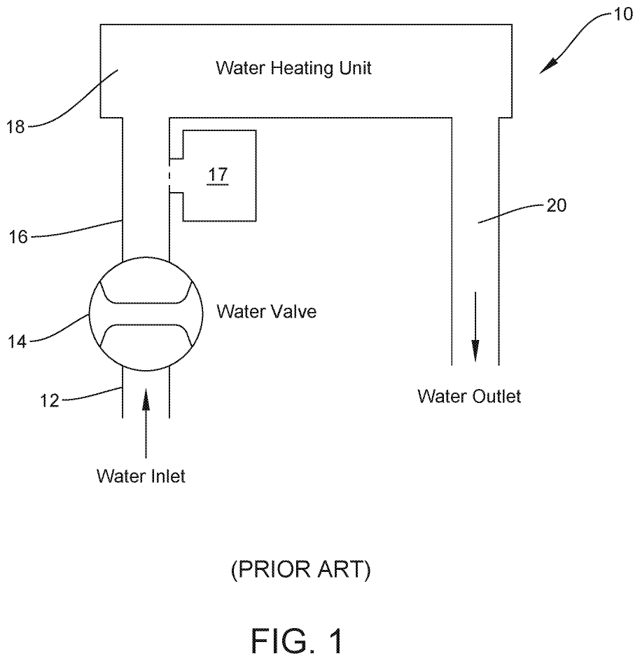

FIG. 1 has been described in the Background of the invention.

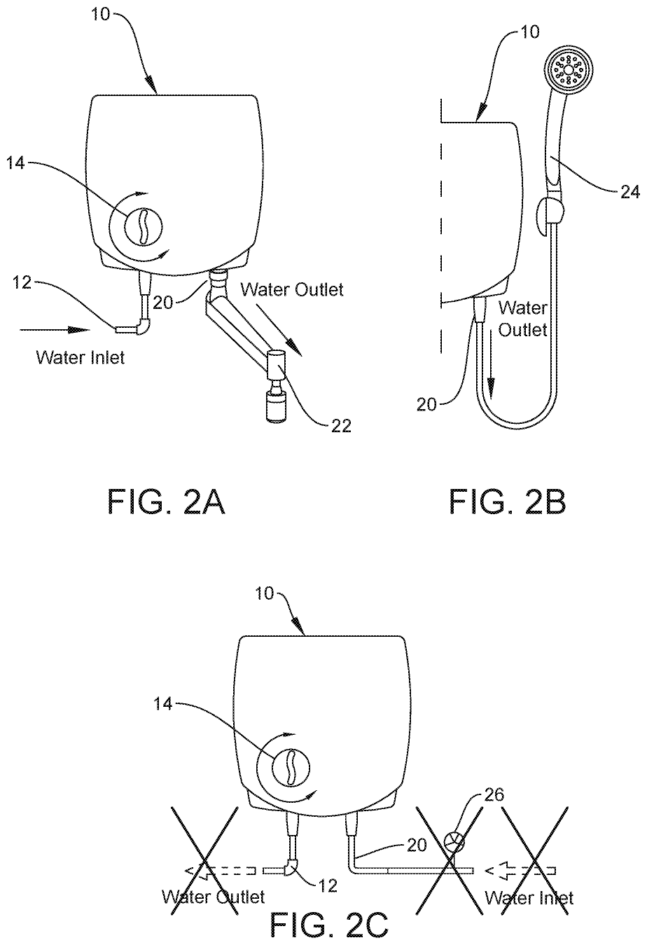

Let us discuss what are correct ways to install the device schematically shown in FIG. 1, and what happens if any typical installation mistake is made during the installation. Correct installation of the open-vented heater is illustrated by examples in FIGS. 2A and 2B.

In the drawings, similar units are marked with similar numbers.

When the heater 10 is installed according to the instructions, the water is usually supplied via a pressure hose to an inlet pipe 12 and, if a water valve 14 is open, flows into a middle (input) pipe 16 then to a water heating unit 18. When a presostat 17 detects water pressure in pipe 16, the water heating unit is switched ON and the water flow is instantly heated. The heated water is continuously discharged from the heater via its water outlet pipe 20.

In one embodiment (FIG. 2A), the water outlet pipe 20 is connected to a free running tap 22. In another embodiment (see FIG. 2B), the water outlet pipe 20 terminates with a showerhead 24. The common feature is that neither 22 nor 24 includes a water valve/tap/shutter controllable by the user, i.e., they are always open to the atmosphere (open-vented). According to the instructions, no stoppers are allowed at the outlet pipe in order to prevent retention and overheating of water in the instant water heater. If, as required by the instructions, the inlet pipe is connected to water supply, the outlet pipe—to water outlet, and if there is no any stopper at the outlet pipe, the electric heater will work properly, namely: if the user opens the water valve 14, the water flow will enter to the heating unit 18 of the device via the input (middle) pipe 16, will be instantly heated in the device and supplied to the user from the outlet pipe 20.

FIG. 2C illustrates an example of Incorrect installation of a regular open-vented instant water heater 10. Two installation mistakes are schematically shown in one and the same drawing, though they may take place separately. As already noted, customers or plumbers may make the following typical mistakes:
a) inverted installation of the outlet 20 and inlet 12 water pipes (i.e. trying to connect them vice-versa). The inverted installation is shown by dotted arrows “Water Inlet” and “Water Outlet”, which are crossed out by black crosses as the prohibited, erroneous ones.
   b) connecting the outlet pipe 20 to a water tap or the like, which may close the normally open outlet pipe (a tap/shutter 26 with a manually operated handle is shown as an example). The device 26 is also crossed out as prohibited.

Any one of the above mistakes is bad enough to cause an irreversible damage to a heating element and other components of the device. Indeed, if (a) or (b), or both of them are erroneously applied, the water gets into the device and sooner or later is trapped in the heating unit which will heat the trapped water up to overheating and damaging of the whole device. It is explained more specifically below.

If only mistake (b) is made, the water will be obstructed in the heating unit whenever the water valve 14 is open and the erroneous tap/shutter 26 is closed. (Actually, a similar dangerous situation may occur if any stopper, clog etc. appears in the outlet pipe 20.)

If mistake (a) is made alone or together with mistake (b), the water may be trapped (obstructed) in the heating unit, for example, when the user closes the water valve 14.

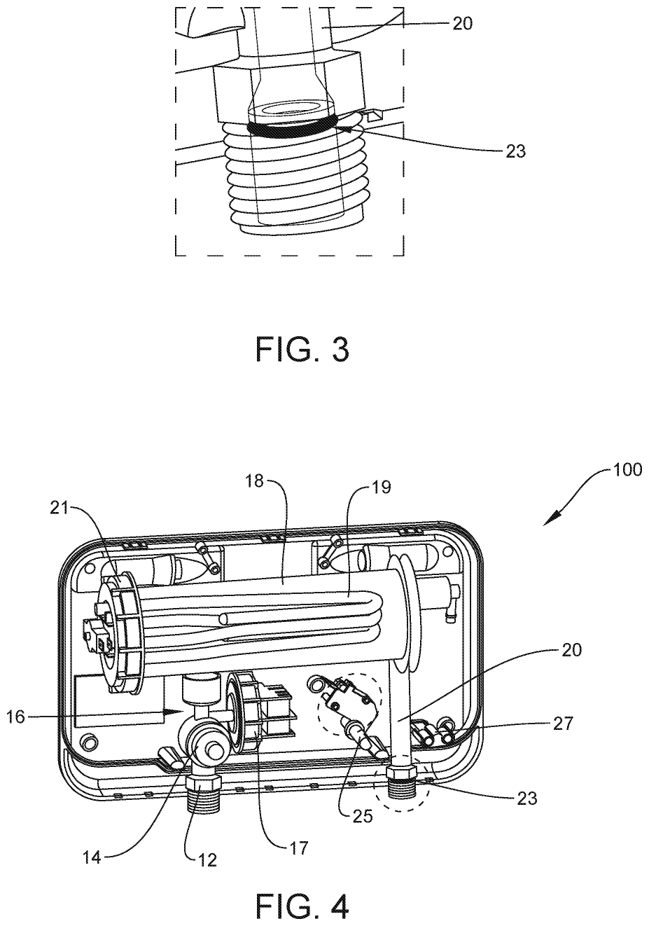

FIG. 3 illustrates one proposed solution to the above problem: a one-way valve 23 is installed in the outlet pipe 20, so as to prevent any water flow from outside into the outlet pipe and further towards the heating unit. In this embodiment, valve 23 is integrated in the outer end of the outlet pipe 20.

FIG. 4 shows one embodiment 100 of the proposed instant water heater, which comprises the inlet pipe 12, the manual water valve 14, the input (middle) pipe 16, the water pressure mechanism (switch) 17 connected to the middle pipe 16, the water heating canister 18 with an electric heating element 19, and a thermostat 21. The heated water flows from the canister 18 to the outlet pipe 20.

The water pressure switch 17 detects water pressure in the middle pipe 16. When the manual valve 14 opens a passage between the inlet pipe and the middle pipe, water enters the middle (input) pipe and is thus inputted to the canister 18. When water pressure in the pipe 16 reaches a predetermined value, the switch 17 puts ON the electric heating element 19.

As shown in FIG. 3, at least one unidirectional valve 23 may be integrated within the outlet pipe 20, in order to prevent a wrong water flow and overheating of the water heater in case of incorrect installation (a). More one-way valves 23 may be installed to increase safety of the heater 100.

In such a case (see FIG. 2C), any one-way valve 23 will prevent the water canister and the middle pipe from water flowing there-into from the outlet pipe, and so will prevent the pressure switch 17 from erroneous activation of the heating element 19. In this way, potential overheating and damages will be avoided. In other words, the electric heater will remain disabled after the erroneous installation, and this fact will serve as an indication to a user/plumber that the device must be re-installed in a correct way. Additional indication means may be introduced, for example a signaling lamp (not shown).

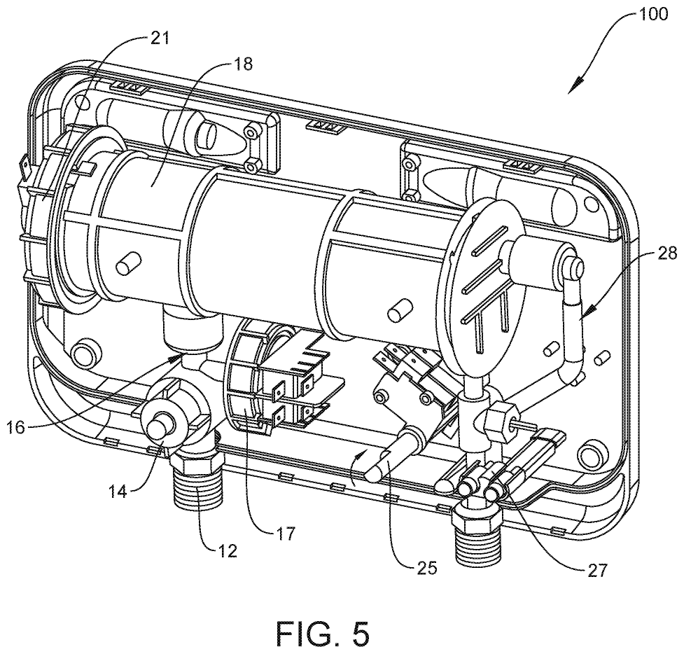

FIG. 5 illustrates yet a further embodiment of the instant water heater 100, which is assembled for securing the device on a wall. Additional elements can be seen in this illustration. For example, the heater is provided with a power setting switch (power selector) 25. It can be manually switched between at least two positions. Various embodiments of the heater may have three or more power levels selectable by the power setting switch 25. The different power levels are associated with different temperatures of the water which may be obtained from the outlet pipe 20. Power indicators 27 are provided to indicate respective selected power levels (two power indicators are shown in this figure).

In this embodiment, an additional, draining pipe 28 is provided to remove excessive water and/or steam from the canister 18. The drain pipe 28 has its own separate outlet orifice (not shown in this drawing).

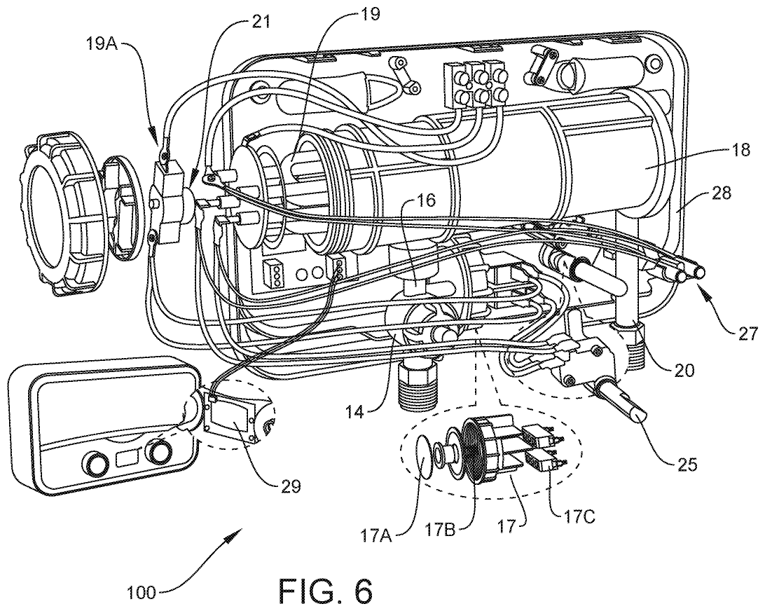

FIG. 6 illustrates a more detailed, exploded embodiment of the instant water heater 100. Power lines and control lines interconnect various elements of the heater. As can be noted, the water pressure switch 17 comprises a membrane 17A and a normal flow switch spring 17B, which together react to a predetermined pressure level of the water flow in the middle pipe 16. When that predetermined pressure level is reached, the switch 17 via its contacts 17C sends a control signal to contacts 19A of a thermostat 21 connected to the electric heating element 19, in order to put the heating element ON. The control signal also depends on the power level selected by the power selector 25: the selected position of the power selector 25 activates corresponding contacts 17C of the pressure switch 17. In parallel, the selected power level is indicated by the corresponding power indicator lamp out of the lamps 27.

The heater 100 may also be provided with a display 29 for indicating the current temperature of the hot water.
Flow sensing devices (one-way valve/s etc.) are not shown in FIG. 6.

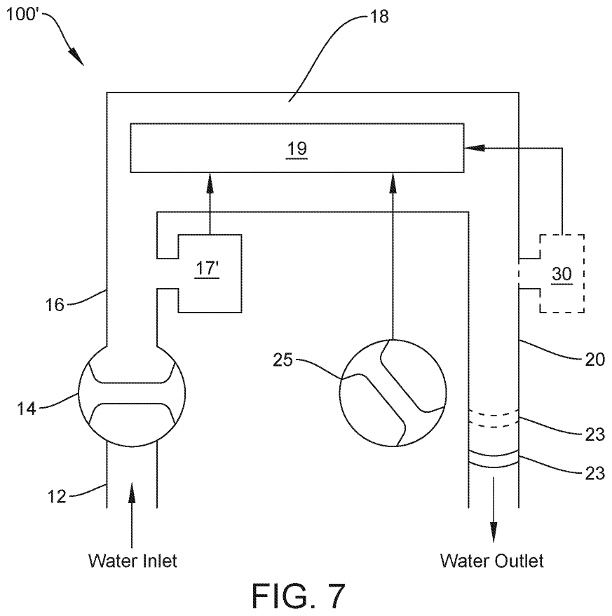

FIG. 7 shows yet another embodiment 100′ of the proposed water heater, which may comprise the following components:
a block 17′, associated with the input (middle) pipe 16 and implemented either as a water pressure mechanism or as an “inlet” water flow mechanism,
an optional, “outlet” water flow mechanism 30 associated with the outlet pipe 20,
An optional second one-way valve 23 (in dotted lines) for double protection of the outlet pipe 20 from a reverse water flow.

Functions of the one-way valve 23 were explained with reference to FIG. 3 and FIG. 4. The heater 100′ is preferably provided with a power setting switch 25, and is controlled according to the power levels selected by means of the power setting switch 25.

In this embodiment, the mechanisms 17′, 30, the power setting switch 25 are in control communication (indicated by arrows) with the heating element 19.

As mentioned above, the water pressure mechanism reacts to a predetermined water pressure. As also mentioned above, the water flow mechanism reacts to existence of a predetermined water flow, and specifically - to the flow direction.

The heating element 19 of the heater 100′ is controlled based at least on readings of the unit 17′ (a water pressure switch or the water flow switch). A predetermined water pressure or a predetermined flow direction (towards the heating unit 18) in the pipe 16 will switch the heating element 19 ON. A current position of the water valve 14 may also be taken into account for controlling the heating element 19 (though a control arrow is not shown here).

In this embodiment, the heating element 19 may be further controlled by indications of the water flow mechanism (the flow sensing device) 30 which is shown by dotted lines.

Let in this embodiment, the water flow mechanism 30 is a flow sensor manufactured by the Applicant's company. The flow sensor comprises a magnet in a plastic ball which is placed in the outlet pipe 20, and an electromagnetic detector which is located at a specific position outside the pipe but in close proximity to the pipe. (Details of the flow sensor 30 are not shown in the drawing.)

The flow sensor 30 is capable of detecting the following events with a certain accuracy, (and providing indications thereof if desired):
1) there is a water flow in the direction from the pipe 20 towards the heating unit 18;
2) there is no flow in the pipe 20 (i.e. either no water at all, or the water is static).

According to this embodiment of the invention, any of the above events 1 and/or 2, while detected by the “outlet” water flow mechanism 30, are adapted to cause the heating element 19 to switch OFF.

Indeed, in case of the inverse installation (installation mistake “a”), the water flow switch 30 will detect a wrong flow direction in the outlet pipe 20 (towards the heating unit 18), so the heating element 19 will be switched OFF.

In case there is a stopper in the outlet pipe 20 (installation mistake “b”), the water flow mechanism 30 will detect the absence of flow (static water) in the pipe 20, so the heating element 19 should be switched OFF.

In case there is no water in the outlet pipe 20, this most probably means that the canister 18 is empty. So when the water flow mechanism 30 indicates the absence of flow, it is anyway logical to switch the heating element 19 OFF.

At least based on the above-described functions of the water flow mechanism, visual indication of installation mistakes may be provided in the proposed water heater (not shown in the drawing).

While the invention has been described with reference to specific embodiments and illustrations, it should be appreciated that other embodiments of the device and additional versions of the method may be proposed and should be considered part of the invention, whenever covered by the claims which follow.

1. An open-vented instant water heater configured so as to prevent damaging thereof in case of incorrect installation; said water heater comprises a water canister with a heating element and a normally open outlet pipe,
wherein the outlet pipe is provided with a flow sensing device comprising at least one of the following:
a one-way valve, allowing a water flow from the water canister outside, while preventing a water flow in the opposite direction;
an outlet water flow mechanism, adapted to switch the heating element OFF whenever detecting in the outlet pipe either absence of a water flow, or a water flow in said opposite direction.

2. The water heater according to claim 1, arranged so as to have:
an input pipe,
said water canister being in flow communication with the input pipe and the outlet pipe,
said heating element adapted for instantly heating water in the canister,
a thermostat in the canister,
a water pressure mechanism or an inlet water flow mechanism, being associated with the input pipe for respectively determining water pressure or water flow in the input pipe, wherein
water flow via the input pipe is regulated by a water valve, and
the heating element is controllable using said water pressure mechanism or said inlet water flow mechanism, by switching the heating element ON when a predetermined water pressure or a predetermined water flow is determined in the input pipe.

3. The water heater according to claim 1, wherein said one-way valve is embedded in the outlet pipe in proximity to the outer end of the pipe.

4. The water heater according to claim 1, wherein said outlet water flow mechanism is connected to the outlet pipe and is sensitive both to presence/absence of a water flow in the pipe, and to a predetermined direction of the water flow in the pipe.

5. The water heater according to claim 4, wherein said outlet water flow mechanism comprises
a magnet in a ball-like shell, and
a magnetic detector,
wherein said magnet is placed in the outlet pipe, while the magnetic detector is located outside the outlet pipe.

6. The water heater according to claim 1, adapted to provide indication of incorrect installation of said water heater.

7. The water heater according to claim 1, provided with a manually operated power setting switch, for regulating power of the heating element.

8. The water heater accordinpg to claim 1, further provided with a drain pipe for outputting overflow of water or steam from the water canister outside.

9. The water heater according to claim 2, comprising said water valve as an internal, manually operated water valve for regulating water flow through the input pipe, said water valve being connected between said input pipe and an inlet pipe.

10. A method for preventing damage of incorrect installation to an open-vented instant water heater having a water canister with a heating element and a normally open outlet pipe, the method comprises providing the water heater having a flow sensing device at the outlet pipe, wherein the flow sensing device comprises a one-way valve and/or a water flow mechanism.

11. The method according to claim 10, comprising controlling the water heater with the installed water flow mechanism, by switching the heating element OFF whenever said water flow mechanism detects in the outlet pipe either absence of a water flow, or a water flow towards the water canister.

12. The method according to claim 10 or 11, further comprising indication in case of incorrect installation of the water heater.
